(19) United States
(12) Patent Application Publication
(10) Pub. No.: US 2019/0172018 A1
(43) Pub. Date: Jun. 6, 2019

(54) STANDBY SYSTEM AND PROCESS

(71) Applicant: Adrenaline Technologies LLC, Alpharetta, GA (US)

(72) Inventor: Mark Alan Heffley, Alpharetta, GA (US)

(73) Assignee: Adrenaline Technologies LLC, Alpharetta, GA (US)

(21) Appl. No.: 15/832,199

(22) Filed: Dec. 5, 2017

(51) Int. Cl. G06Q 10/10; G07F 17/42; G06Q 30/04

(52) U.S. Cl. CPC G06Q 10/1095; G06Q 30/04; G07F 17/42

(57) ABSTRACT

A method and apparatus to schedule service requests is disclosed. The method includes assigning customers a requested appointment time slot and customer requested standby appointment time slot preference based on a list of presently available time slots stored in a datastore. Additional time slots periodically become available and are stored as updated available time slots in the data store. The customer requested standby appointment time slots preferences are matched to the updated available time slots. Upon a match, a signal is sent to a customer to indicate to the customer that their requested standby appointment time slot preference has been scheduled.

### TECHNICAL FIELD

These claimed embodiments relate to a standby processing system and process, and more particularly to automatically alerting and rescheduling of customer appointment times based on customer requests.

### BACKGROUND OF THE INVENTION

A method and apparatus for automatically alerting and rescheduling of customer appointment times based on customer requests is disclosed.

Customers typically schedule appointment times for services, such as repairing defective equipment and obtaining new devices, by contacting the service company. The company then reviews available appointments and schedules the customer appointment time based on currently available time slots. Often the customers preferred appointment time is not available, and thus the customer receives an appointment time that is less convenient or is too far in the future.

Also many of the scheduled appointment times are subsequently cancelled by the customer and additional resources to service appointments become available, thereby freeing up valuable appointment time slots. Typically, the customer must repeatedly call again to book a new service appointment or else the customer may not receive these newly available appointment time slots. This results in resources to service the appointment sitting idle, thereby reducing the service company's productivity and increasing servicing expense.

### SUMMARY OF THE INVENTION

In one implementation, a method is disclosed that schedules service requests. The method includes assigning customers a requested appointment time slot to presently available time slots stored in a datastore and/or storing in a datastore customer requested standby appointment time slot preferences to presently unavailable time slots indicated with the datastore. An updated availability of the slots is stored in the datastore based on periodically received information indicating additional service resource availability or customer cancellation of appointment time slots. The customer requested standby appointment time slot preferences is matched to the appointment time slots with updated availability. A notification indication is sent to a customer that corresponds to the matching customer requested standby appointment time slot preferences to indicate to the customer that at least one of their requested standby appointment time slot preferences has been scheduled.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a simplified schematic diagram of a standby appointment system for rescheduling service appointments;

FIG. 2 is a simplified system diagram of a standby appointment system for rescheduling service appointments;

FIG. 3 is a simplified schematic diagram of an agent dashboard, contact manager, ticketing, and middleware computing device shown in FIG. 2;

FIG. 4 is a flow chart of a process for creating a standby request that is used to reschedule service appointments by the standby processing devices shown in FIGS. 1 and 2;

FIG. 5 is a flow chart of a process for creating a process request that is used to reschedule service appointments by the standby processing devices shown in FIGS. 1 and 2.

FIGS. 6-8 are screen shots of appointment screens showing appointment slots used in entering a standby request;

FIG. 9 is screen shot showing active tickets in the datastore that is used to alert customers of changes in service appointments;

FIG. 10 is a screen shot showing customer information that is used to update customer information.

### DETAILED DESCRIPTION

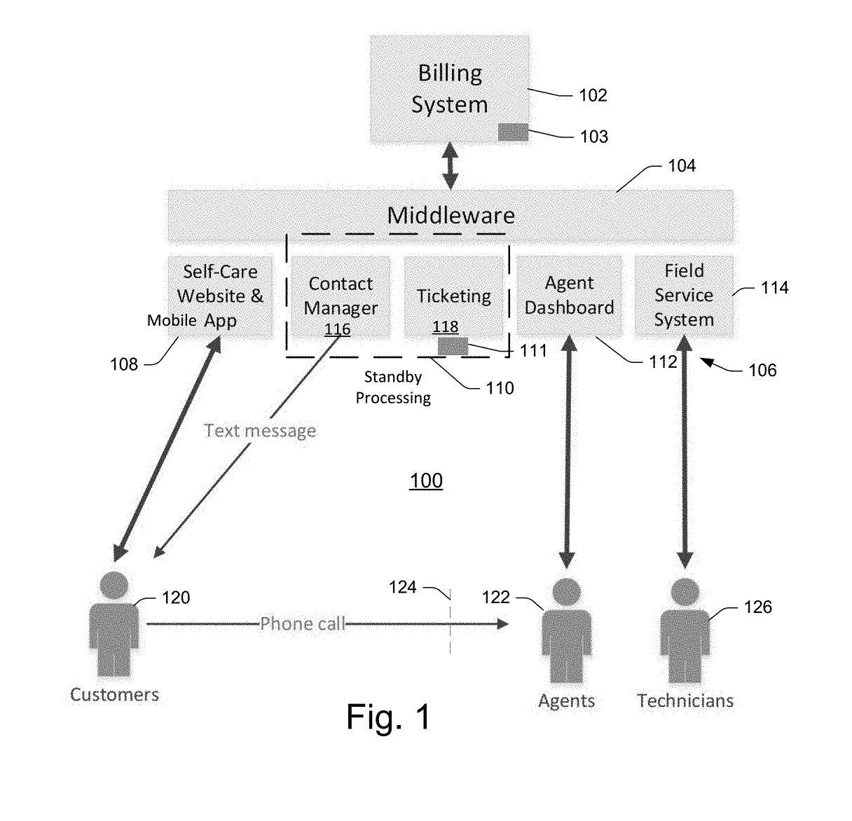

Referring to FIG. 1 there is shown a simplified schematic diagram of a standby appointment system 100 for rescheduling service appointments. System 100 includes a billing system 102 coupled via middleware 104 to applications 106. Billing system 102 includes a datastore 103. Applications 106 include a self-care website and mobile application 108, a standby processing application 110, an agent dashboard application 112, and a field service system application 114. Standby processing application 110 includes a datastore 111, a contact manager application 116 and ticketing application 118 coupled with middleware 104. Datastore 103, in one implementation may be the same as datastore 111 or in another implementation may be a separate datastore.

One or more customers 120 communicate with self-care website and mobile application 108 via a wide area network such as the internet, and communicate with contract manager application 116 via a telecommunication service such as text messaging. Customers 120 using a device such as a mobile phone or land phone communicate with agents 122 via a telecommunications call center 124, and agents 122 communicate with agent dashboard application 112 via a local network or via the internet. Field service system application 114 may communicate with technicians 126 via a local network or via the internet.

During operation customers 120 contact agents 122, or using self-care website and mobile application 108 request a preferred appointment time slot via the telecommunication call center 124. Multiple calls may be routed within the call center 124 to a call center representative (e.g. agent 122) for entry by the agent 122 of the requested appointment time slot preference into the datastore 103. Available times slots are stored in datastore 103 and are periodically updated by billing system 102 in response to cancellations of customers of appointment time slots or when additional service personnel/technician 126 resources become available. Such appointment times slots may be defined by a range of times. When such available times slots are updated, in one implementation an event manager module (in middleware and not shown) may provide an indication to ticketing application 118 upon a match of customer 120 requests.

Upon receiving the call from customers 120, the agent/representative 122 enters customer time slot preferences received from customers 120 to assign customers 120 a requested appointment time slot to presently available time slots stored in datastore 103. In addition, if the requested appointment time slot is not available, the representative may store in datastore 103 customer 120 requested standby appointment time slot preferences to presently unavailable slots indicated with the datastore 103. Although such appointment times (for appointment time slots and appointment time slot preferences) may be entered by agent 122, such appointment times may be directly entered by customer 120 using customer mobile device or computing device that communicates wirelessly via a network with self-care website and mobile application 108.

In response to an indication of an update from event manager module, ticketing system automatically matches the one or more customer requested standby appointment time slot preferences to the one or more appointment time slots with updated availability. Ticketing application 118 sends a notification indication, to a customer 120 via contact manager 116, which corresponds to the matching one or more customer requested standby appointment time slot preferences to indicate to the customer 120 that at least one of their requested standby appointment time slot preferences has been scheduled. Such notification indication may be automatically signaled to the customer using contact manager 116 via text messaging, instant messaging, via email, or a voice call. In addition, contact manager may be programmed to automatically send a reminder, indicating the time of the appointment time slot matching the at least one of the customers 120 requested standby appointment time slot preferences, to the customer 120. Such reminder may be sent a predetermined time period (n hours, n days, n weeks, etc. where n is an integer) before a scheduled time of the appointment time slot.

In one implementation, the ticketing application 118 matching the customer requested standby appointment time slot preferences to the appointment time slots with updated availability may include: selecting one of the customers 120 for matching in a priority order. Such priority order may be based on a) a location of the customer, b) a date the selected customer provided the requested standby appointment time slot preferences, or c) a preference level characteristic assigned to each of the customers 120. Exemplary preference level characteristics may include revenue provided by customer, a longevity of service with the customer, a tier level of service of the customer, a relationship of the customer with the company or its employees, or particular demographics of the customer.

In one implementation, the ticketing application 118 may automatically provide an indication to the field service system application 114, e.g. a service center, via the billing system 102. Such indication may indicate the available time slot matching the at least one of the customers requested standby appointment time slot preferences with corresponding customer contact information. Sending of such indication may commit the appointment time slot to the service center.

In another implementation, the customer using a mobile smart phone or other smart device may provide a signal via a telecommunications network back to the ticketing application. This signal may indicate confirmation by the customer that the customer acknowledges that the requested standby appointment time slot has been scheduled.

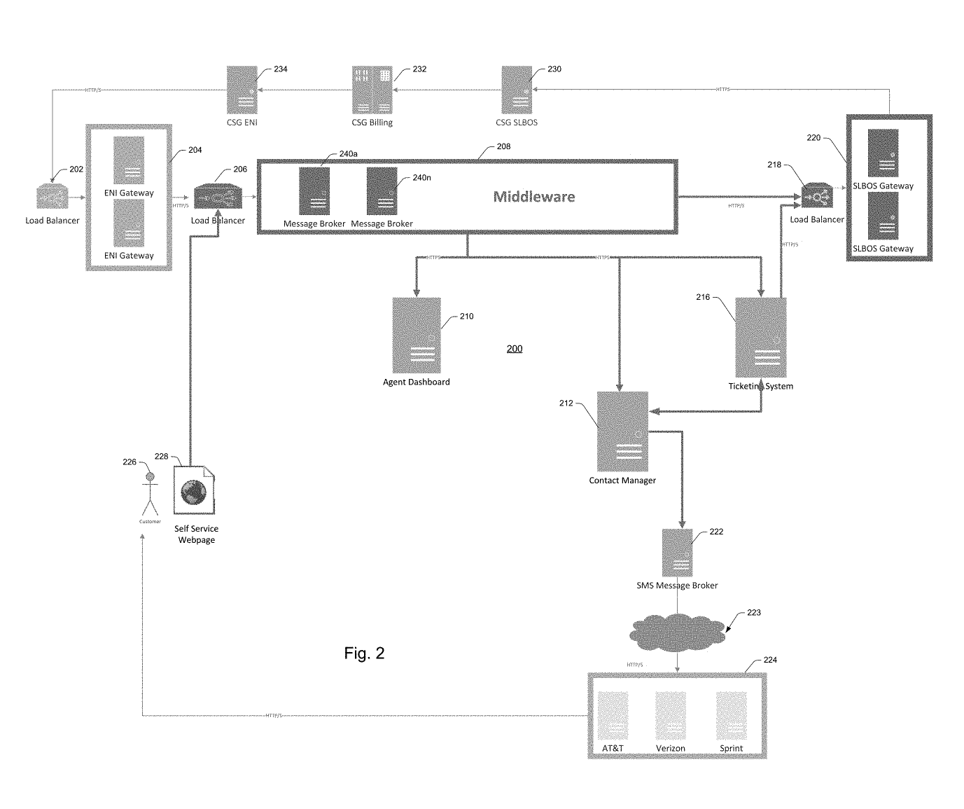

Referring to FIG. 2, there is shown a standby appointment system 200 for rescheduling service appointments. System 200 includes a load balancer 202 coupled through ENI Gateway 204 and load balancer 206 to Middleware system 208. Middleware systems 208 is coupled via a network to Agent dashboard 210, contact manager 212, and ticketing system 216. Contact manager 212 is coupled to and receives notifications of changed appointment times with ticketing system 216. Contact manager 212 provides the most recent updates of contact information with SMS broker 222 and/or ticketing system 216.

Middleware system 208 is coupled via load balancer 218 to SLBOS gateway 220. Middleware system 208 includes Message brokers 240a and 240n. SMS message Broker 222 is coupled via an internet or wide area network (cloud 223) to a carrier system 224 (e.g. AT&T, Verizon, Sprint, T-Mobile) that communicates SMS messages (received from ticketing system 216) with customer 226. Load balancer 206 is coupled via Self Service webpage 228.

SLBOS Gateway 220 communicates with load balancer 206 via CSG SLBOS 230, CSG billing System 232, and CSG ENI 234. CSG Billing System 232 is shown as billing system 102 in FIG. 1.

Agent dashboard 210 processes standby requested placed in a troubleshooter. Agent dashboard 210 provides an indication when a customer agrees to receive text notifications of changes to the customer's appointment time.

Ticketing system 216 stores standby tickets, and receives quota change notifications in priority order (priority order may be set as discussed previously in connection with FIG. 1) as time slots become available. Ticketing system 216 notifies customers 226 of changes of appointment times using the provided contact information from contact manager 212. Ticketing system 216 may checks available times slots to see if customer standby requests (requested appointment times) can be made available to customer 226.

### EXAMPLE COMPUTING DEVICE ARCHITECTURE

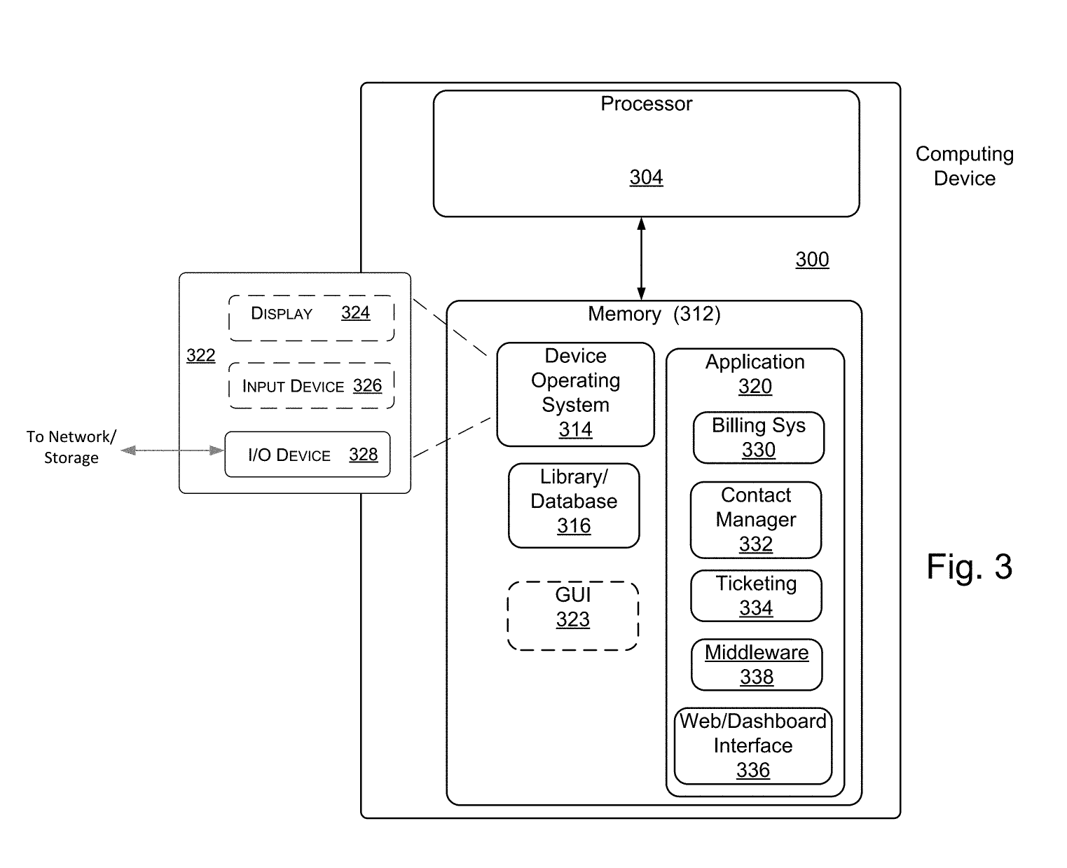

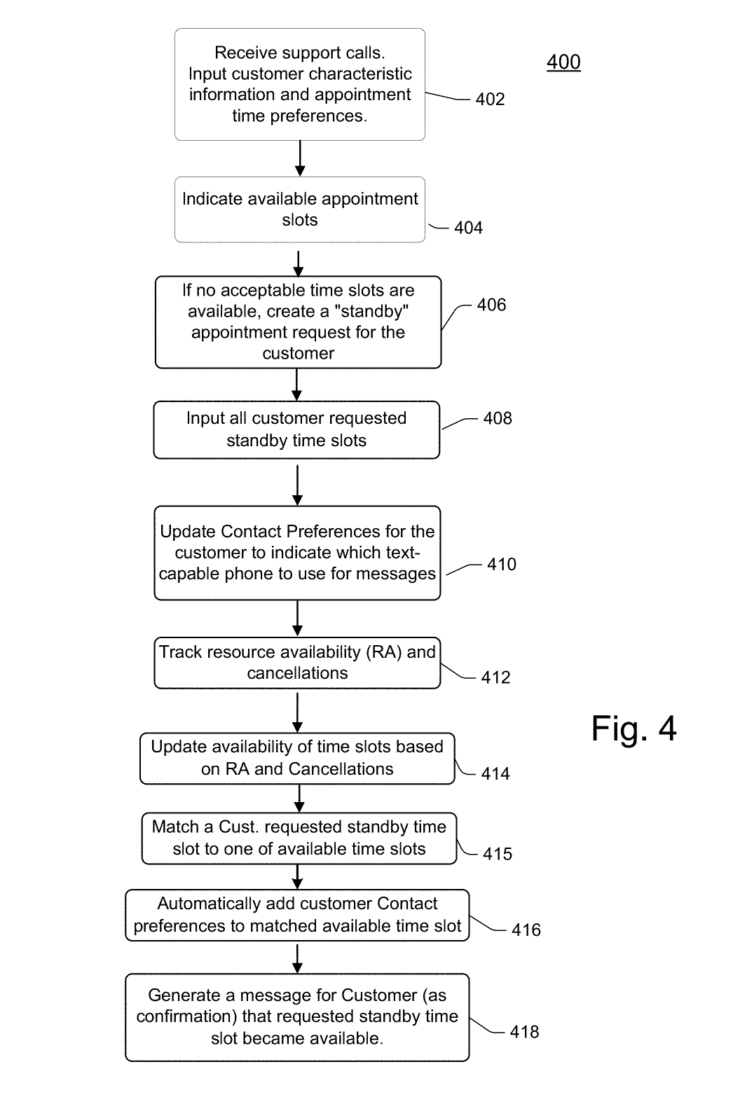

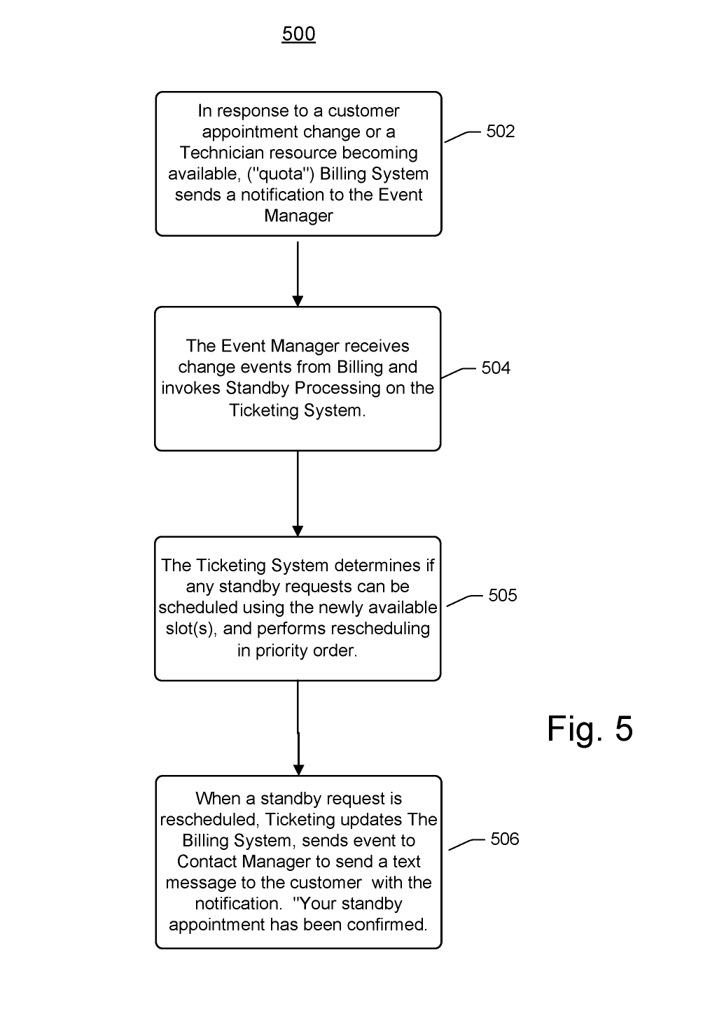

In FIG. 3 are illustrated selected modules in computing device 300 using processes 400 and 500 shown in FIGS. 4-5, to create standby appointments. Computing device 300 (such as computing devices 208-216 shown in FIG. 2) includes a processing device 304 and memory 312. Computing device 300 may include one or more microprocessors, microcontrollers or any such devices for accessing memory 312 (also referred to as a non-transitory media) and hardware 322. Computing device 300 has processing capabilities and memory suitable to store and execute computer-executable instructions.

Computing device 300 executes instructions stored in memory 312, and in response thereto, processes signals from hardware 322. Hardware 322 may include an optional display 324, an optional input device 326 and an I/O communications device 328. I/O communications device 328 may include a network and communication circuitry for communicating with network or an external memory storage device, such as a datastore.

Optional Input device 326 receives inputs from a user of the computing device 300 and may include a keyboard, mouse, track pad, microphone, audio input device, video input device, or touch screen display. Optional display device 324 may include an LED (Light Emitting diode), LCD (Liquid Crystal display), CRT (Cathode Ray Tube) or any type of display device to enable the user to preview information being stored or processed by computing device 304.

Memory 312 may include volatile and nonvolatile memory, removable and non-removable media implemented in any method or technology for storage of information, such as computer-readable instructions, data structures, program modules or other data. Such memory includes, but is not limited to, RAM (Random Access Memory), ROM (Read Only Memory), EEPROM (Electrically Erasable Programable Read only memory), flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information which can be accessed by a computer system.

Stored in memory 312 of the computing device 300 may include an operating system 314, an appointment assignment system application 320 and a library of other applications or database 316. Operating system 314 may be used by application 320 to control hardware and various software components within computing device 300. The operating system 314 may include drivers for device 300 to communicate with I/O communications device 328. A database or library 318 may include preconfigured parameters (or set by the user before or after initial operation) such a server operating parameter, server libraries, HTML (Hypertext Markup Language) libraries, API's and configurations. An optional graphic user interface or command line interface 323 may be provided to enable application 320 to communicate with display 324.

Application 320 may include a billing system module 330, a contact manager module 332, a ticketing module 334, middleware module 338 and a web/dashboard interface module 336. Web/dashboard interface module 336 may include a self-care website and mobile application interface module, an agent dashboard module and/or a field service system module. Contact manager module includes instructions to receive an indication from an event manager of additional service resource availability or customer cancellation of appointment time slots from a billing system. A separate billing system stores in the data store one or more updates to a listing of available appointment time slots based on additional service resource availability or the customer cancellation of appointment time slots. The contact manager module in response to the indication from the event manager, invokes a standby processing event on the ticketing system module.

The ticketing module 334 responds to the invoking of the standby processing event by assigning one or more customers a requested appointment time slot and one or more customer requested standby appointment time slots based on a list of presently available time slots stored in the datastore. The ticketing module 334 responds to the event manager indicating that updates to available time slots were made in the billing system. The event manager responds to updates to the datastore 103 in response to additional service resource availability or customers cancelling appointment time slots.

The ticketing system 334 matches more customer requested standby time slots to the updates to the available time slots based on a predetermined priority order, and provides an indication to the customer manager to inform a customer 120, corresponding to the matching customer requested standby time slots, that the customer requested standby appointment time slot has been scheduled.

Illustrated in FIGS. 4 and 5, are exemplary processes 400 and 500 for scheduling requested appointment times. Such exemplary processes 400 and 500 may be a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to FIG. 3, although it may be implemented in other system architectures.

Referring to FIG. 4, a flowchart of process 400 executed by a standby processing application 320 (See FIG. 3) (hereafter also referred to as “application 320”) is shown. In one implementation, process 400 is executed in a computing device, such as computing device 202 (FIG. 2). Application 320, when executed by the processing devices, uses the processor 304 and one or more of modules 330-336 shown in FIG. 3.

In block 402, application 320 (e.g. dashboard module 330 or web/dashboard interface 336) receives input from an agent in response to support calls (via a telecommunications call center) from the customer. In block 404, available appointment slots are highlighted, and unavailable slots are blacked out.

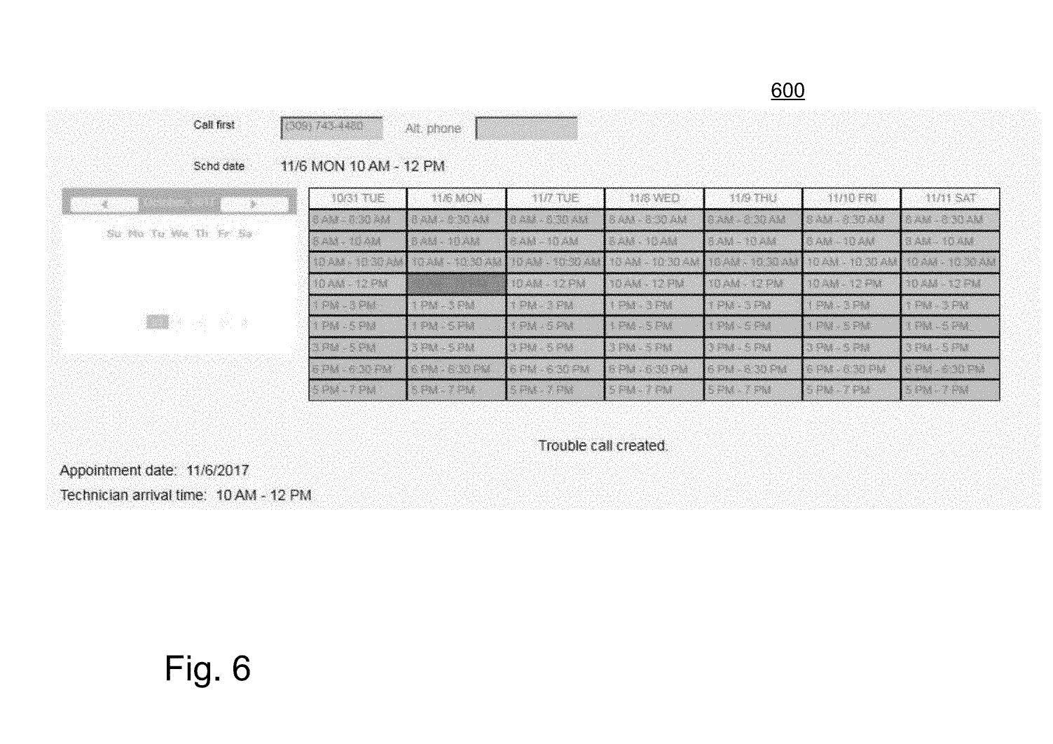

Customer characteristic information and appointment time preferences of customer are then inputted using a screen format 600 as shown in FIG. 6. In on implementation, such appointment time may be inputted by highlighting a particular time slot that was not previously highlighted/blacked out.

In one implementation, preferences of customer are inputted by the agent using screen formats shown in FIG. 6-8, in another implementation such preferences of customer may be directly inputted by the customer using a customer computer or a customer mobile device using screen formats like the formats shown in FIGS. 6-8.

In block 406, if not acceptable time slots are available (as shown on the display), a “standby” appointment requested is created by the customer.

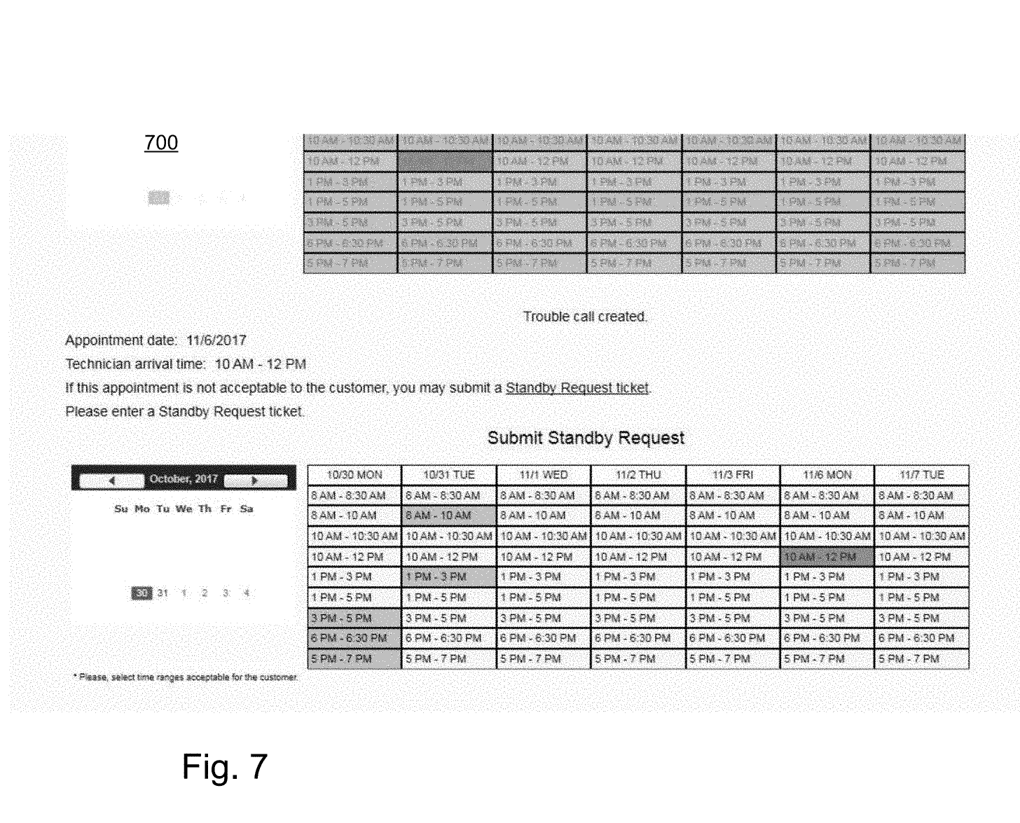

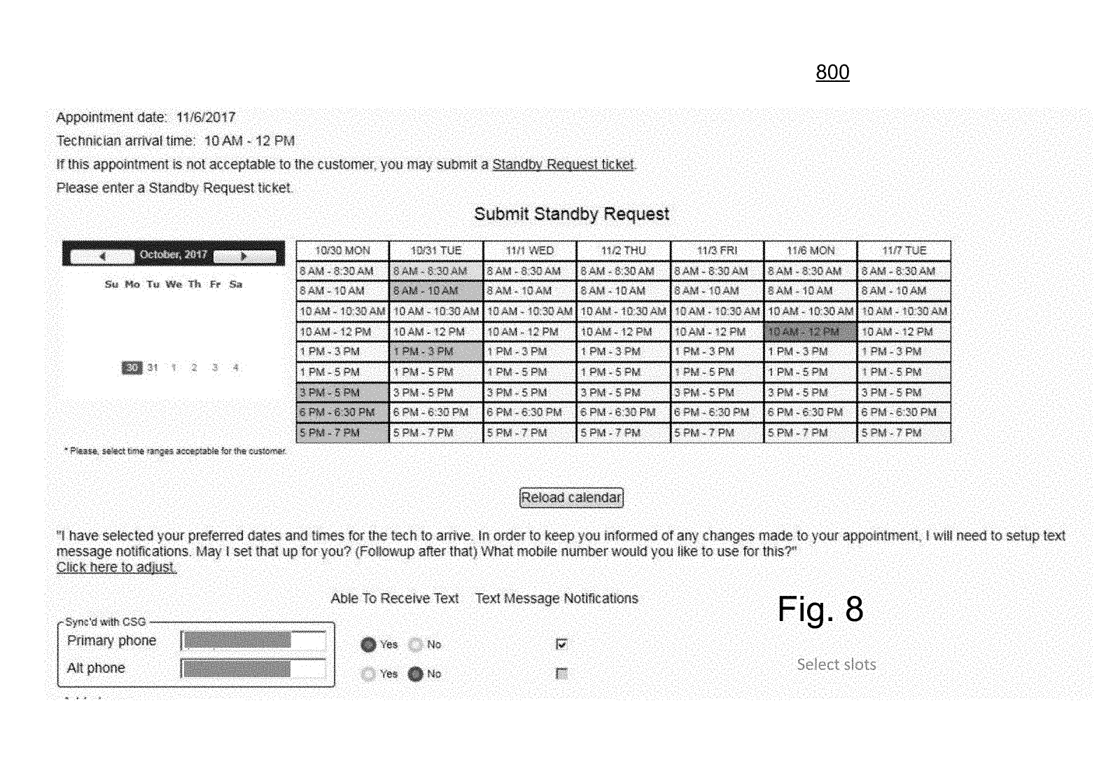

In block 408, all customer requested standby requested time slots are inputted/selected using for example screen 700 as shown in FIG. 7. Such requested slots are highlighted as shown in screen 800 of FIG. 8.

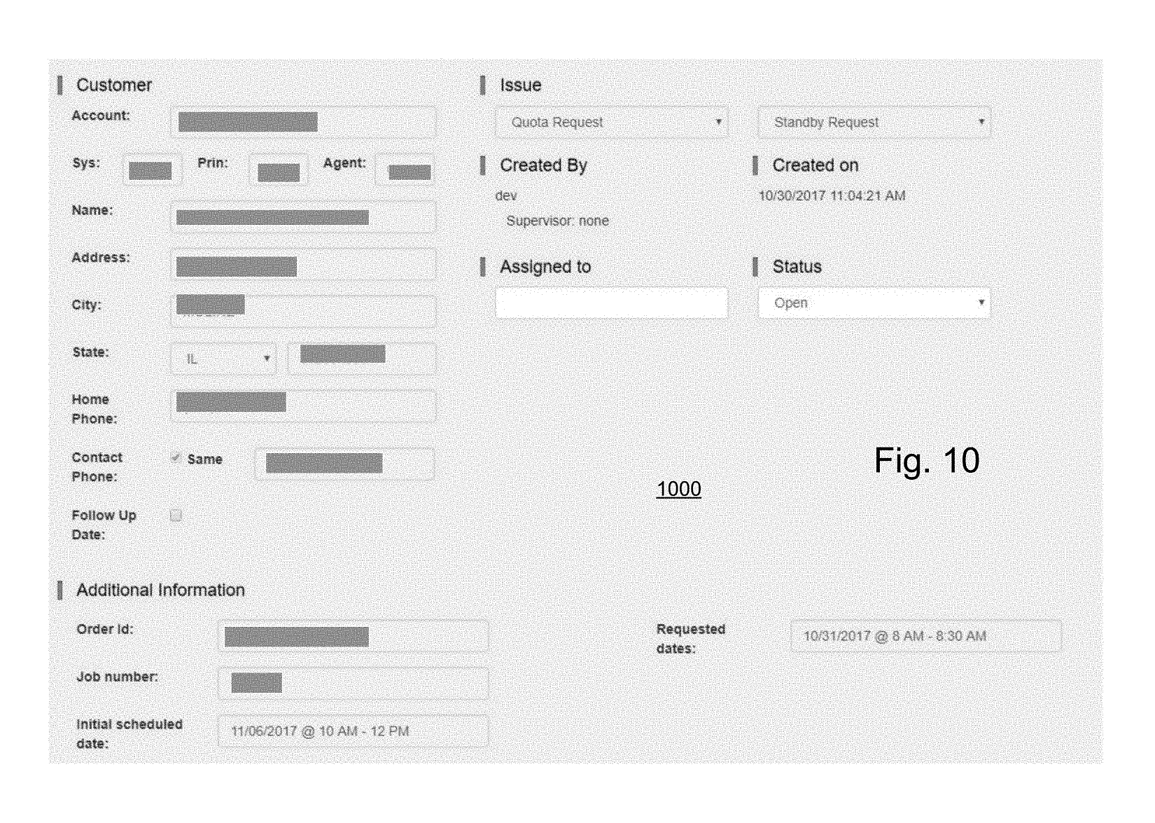

In block 410 contact preferences for the customer to enable the system to indicate which text capable phone to use for messages is updated using display screen 1000 shown in FIG. 10.

In block 412, resource availability and cancellations are tracked with event manager application.

In block 414, the availability of times slots is updated automatically in response to changes to resource availability or cancellations.

In block 415, a customer requested standby time slot is automatically matched to one of the available time slots.

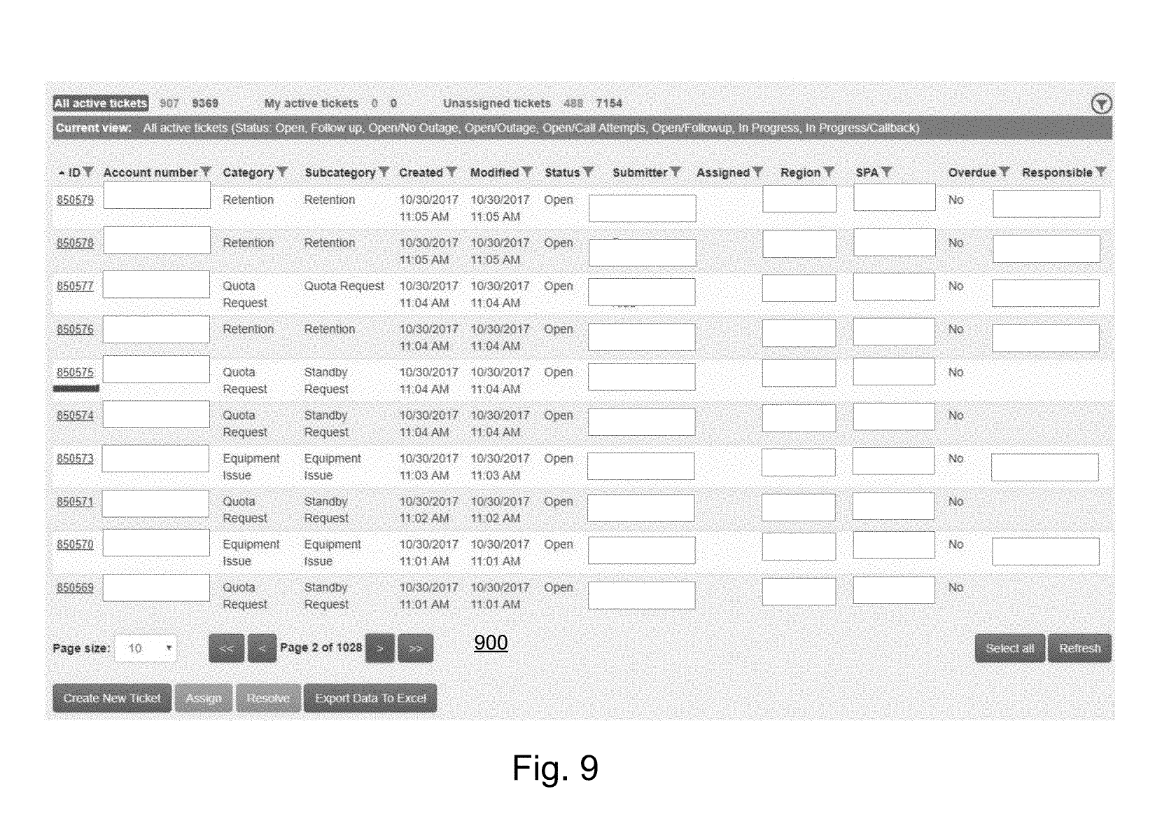

In block 416, the customer contact preferences are automatically matched to available time slot. A ticket is also generated for the matched slot and stored in the datastore. Exemplary tickets are on display 900 in FIG. 9.

In block 418, a message for the customer is generated as confirmation of the change in appointment time. The customer that requested the standby time slot is then sent the message in response to the time slot becoming available.

Referring to FIG. 5, there is shown a flow diagram illustrating a process 500 for creating a request that is used to reschedule service appointments by the standby processing devices shown in FIGS. 1 and 2.

Process 500 may be implemented using an application 320 in computing device 308 shown in FIG. 3.

In block 502, in response to a customer appointment change or a Technician resource becoming available, (“quota”) billing system sends a notification to the Event manager.

In block 504, the event manager receives changes events from the billing system and invokes standby processing on the ticketing system.

In block 505, the ticketing system determines if any standby requests can be scheduled using the newly available slots(s), and performs rescheduling in a priority order (as previously described).

In block 506, when a standby request is rescheduled, ticketing system updates the billing system. Event manager notifies the contact manager to send a text message to the customer with a notification, e.g. “your standby appointment has been confirmed”. Event manager may wake up other modules on changes/updates in the billing system (such as when resources/personnel becomes available or a cancellation in an appointment). All standby requests are stored as tickets in ticketing manager.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

1. A system for scheduling of service requests fed via a network to a scheduling server, the method comprising:
Circuitry to store in a datastore an indication of an availability of a plurality of appointment time slots;
Circuitry to receive a request for a first appointment time slot of the plurality of appointment time slots via the network by a first customer;
circuitry to store in the datastore an indication of an assignment of the first customer to the first appointment time slot in response to the request and an indication in the datastore that the first appointment time slot is presently available;
store in a datastore, in response to storing an assignment of the first customer to the first appointment time slot in the datastore, an unavailability indication of the first appointment time slot;
Circuitry to receive a request for a second appointment time slot of the plurality of appointment time slots and a plurality of standby appointment time slot preferences including the first appointment time slot via the network from a second customer;
Circuitry to store in the datastore an indication of an assignment of the second appointment time slot, requested via the network by the second customer, to one of the plurality of time slots indicated presently available with the datastore and to the second customer, and store in the datastore the plurality of standby appointment time slot preferences including the first appointment time slot, requested by the second customer via the network, to appointment time slots indicated presently unavailable in the datastore;
Circuitry to store in the datastore a presently available indication for one of the plurality of appointment time slots previously indicated presently unavailable, including the first appointment time slot, in response to periodically received resource information received via the network, the resource information being provided via the network in response to the first customer cancellation of the first appointment time slot;
Circuitry to match the one of the plurality of standby appointment time slot preferences requested by the second customer to the one of the plurality of appointment time slots previously indicated unavailable but presently available including the first appointment time slot cancelled by the first customer, the circuitry to match including circuitry to select each of the plurality of standby appointment time slot preferences requested by the second customer in a chronological order and compare the selected standby appointment time slot preferences against one of the plurality of appointment time slots previously indicated unavailable but presently available until one of the selected plurality of standby appointment time slot preferences requested by the second customer matches the one of the plurality of appointment time slots previously indicated unavailable but presently available;
Circuitry to store in the datastore in response to the matching an indication of an assignment of the second customer to the first appointment time slot, the assignment of the second customer to the first appointment time slot preventing a reduction in network bandwidth by increasing the likelihood of the second customer accepting the first appointment time slot without contacting the scheduling server via the network to request another appointment time slot; and
circuitry to send, in response to the assignment of the second customer to the first appointment time slot, a notification to the second customer via the network that one of the plurality of second customer requested standby appointment time slot preferences, including the first appointment time slot, has been scheduled without requiring the second customer to connect with the scheduling server via the network to obtain an earlier appointment time slot than the first appointment time slot thereby providing a reduction in network bandwidth.

2. The method as recited in claim 1, further comprising:
receiving from the second customer the requested appointment time slot preference via a call center in which multiple calls are routed within the call center to a call center representative for entry of the requested appointment time slot preference by the representative into the datastore.

3. The method as recited in claim 1, wherein the presently available indication for one of the plurality of appointment time slots are stored in a datastore by a billing processing system.

4. The method as recited in claim 1, wherein matching the one of the plurality of standby appointment time slot preferences requested by the second customer to the one of the plurality of appointment time slots previously indicated unavailable but presently available includes:
selecting the second customer for matching based on:
a) a location of the second customer,
b) a date the second customer provided the requested standby appointment time slot preferences, or
c) a preference level characteristic assigned to the second customer.

5. The method as recited in claim 1, wherein the notification is automatically sent to the second customer via at least one of text messaging, instant messaging, email, or a voice call.

6. The method as recited in claim 1, wherein the notification is sent to the second customer in response to the requested time slot matching one of the plurality of requested standby appointment time slot preferences.

7. The method as recited in claim 1, further comprising in response to the matching, automatically providing an indication to a service center via the network the first appointment time slot with the second customer contact information.

8. The method as recited in claim 1 further comprising sending a reminder, indicating the time of the appointment time slot, matching the second customer requested standby appointment time slot preference, to the second customer a predetermined time period before a scheduled time of the second appointment time slot.

9. The method as recited in claim 1, wherein the plurality of standby appointment time slots are defined by a range of time.

10. A standby processing system to reduce network bandwidth during a scheduling of service requests fed via a network from a plurality of customers, the standby processing system comprising:
a datastore to store an indication of an availability of a plurality of appointment time slots;
a contact manager server:
a) receiving an indication of (a) additional service resource availability or (b) one customer of the plurality of customer's cancellation of one of the plurality of appointment time slots from a billing system via the network, the billing system updating in the datastore the indications of available appointment time slots in response to additional service resource availability or the one customer's of the plurality of customers cancellation of one of the plurality of appointment time slots; and
b) in response to the indication, invoking via the network a standby processing event on a ticketing system server; and
the ticketing system server responding to the invoking of the standby processing event by the contract manager server by:
a) assigning each of the plurality of customers a requested appointment time slot and each of the plurality of customers a plurality of standby appointment time slots based on the indication of availability of the plurality of appointment time slots stored in the datastore;
b) determining updated indications of available appointment time slots based on information in the datastore indicating additional service resource availability or one customer of the plurality of customers' cancellation of one of the plurality of appointment time slots,
c) matching one of the plurality of standby appointment time slots of a selected one of the plurality of customers to the updated indications of available time slots, the matching performed by selecting for matching the plurality of standby appointment time slots in a chronological order until one of the plurality of standby appointment time slots matches one of the indicated available time slots, the selected one of the plurality of customers selected from the plurality of customers for matching the selected customer's plurality of standby appointment time slots to the updated indications of available time slots based on a predetermined priority order, the matching preventing a reduction in network bandwidth by increasing the likelihood of the selected customer accepting the selected appointment time slot without contacting the ticketing system server via the network to request another appointment time slot, and
d) providing an indication to the customer manager that the selected one of the plurality of customers, has the matching one of the plurality of customer requested standby time slots, to enable the customer manager to inform the selected customer via the network that an appointment time corresponding to one of the selected customer's plurality of requested standby appointment time slots has been scheduled without requiring the selected customer to connect via the network with the standby processing system to obtain an earlier appointment time slot than the scheduled appointment time slot thereby preventing a reduction in network bandwidth.

11. The system as recited in claim 10, wherein matching one of the plurality of standby appointment time slots of the selected one of the plurality of customers to the updated indications of available time slots, the selected one of the plurality of customers selected from the plurality of customers for matching the selected customer's plurality of standby appointment time slots to the updated indications of available time slots based on the predetermined priority order includes:
selecting with the ticketing system one of the plurality of customers for matching based on:
a) a location of the one customer,
b) a date the one customer provided the requested standby appointment time slot preferences, or
c) a preference level characteristic assigned to the one customer.

12. The system as recited in claim 10, wherein the ticketing system matching one of the plurality of customers requested standby appointment time slots to the updated indications of the available time slots based on a predetermined priority order includes selecting with the ticketing system one of the plurality of customers for matching based on a preference level characteristic assigned to the one customer, and wherein the preference level characteristic assigned to the one customer is based on at least one of a customer revenue provided, a customer longevity, a customer tier level of service, or a type of customer relationship.

13. The system as recited in claim 10, further comprising transmitting via the network with the ticketing system a reminder indication, indicating the time of the appointment time slot, matching the at least one of the customers requested standby appointment time slots, to the selected customer of the plurality of customers a preconfigured fixed time period before a scheduled time of the appointment time slot.

14. The system as recited in claim 10, wherein ticketing system automatically sends a signal to the selected customer via the network at least one of text messaging, instant messaging, email, or a voice call, and wherein ticketing system receives a response from the selected customer via the network indicating confirmation by the customer that the customer acknowledges that the requested standby appointment time slot has been scheduled.

15. A computer readable storage medium storing a plurality of instructions for execution by a processor, the computer readable storage medium comprising:
instructions for reducing network bandwidth during a scheduling of service requests by a service provider fed via a network to a scheduling server, the instructions including:
instructions for storing in a datastore an indication of an availability of a plurality of appointment time slots;
instructions for requesting a first appointment time slot of the plurality of appointment time slots via the network by a first customer of a plurality of customers;
instructions for responding to the request for the first appointment time slot of the plurality of appointment time slots and to an indication in the datastore that a first appointment time slot of the plurality of appointment time slots is presently available by storing in the datastore an indication of an assignment of the first customer to the first appointment time slot;
instructions for storing in a datastore, in response to storing an assignment of the first customer to the first appointment time slot in the datastore, an unavailability indication of the first appointment time slot;
instructions for receiving a request for a second appointment time slot of the plurality of appointment time slots and a plurality of standby appointment time slot preferences including a preference for the first appointment time slot via the network from a second customer;
instructions for storing in the datastore an indication of an assignment of the second appointment time slot indicating a later time than the first appointment time slot and requested via the network by the second customer of the plurality of customers, to one of the plurality of time slots indicated presently available with the datastore and to the second customer, and for storing in the datastore in response to a request by the second customer via the network, the plurality of standby appointment time slots preferences for the second customer, including the preference for the first appointment time slot, to one of the plurality of appointment time slots indicated presently unavailable in the datastore;
instructions for storing in the datastore, in response to storing the indication of the assignment of the second customer to the second appointment time slot in the datastore, an unavailability indication of the second appointment time slot instructions for providing resource information via the network in response to a cancellation by the first customer of the first appointment time slot;
instructions for storing in a datastore a presently available indication for one of the plurality of appointment time slots previously indicated presently unavailable in response to periodically received resource information received via the network indicating a cancellation by the first customer of the first appointment time slot;
instructions for matching the one of the plurality of customer requested standby time slots preferences requested by the second customer to the one of the plurality of appointment time slots previously indicated unavailable but presently available including the first appointment time slot cancelled by the first customer, the matching performed by selecting for matching the plurality of standby appointment time slot preferences requested by the second customer in a chronological order until one of the plurality of standby appointment time slots preferences matches one of the plurality of appointment time slots previously indicated unavailable but presently available;
instructions for responding to the matching by storing in the datastore an indication of an assignment of the second customer to the first appointment time slot, the assignment of the second customer to the first appointment time slot preventing a reduction in network bandwidth by increasing the likelihood of the second customer accepting the first appointment time slot without contacting the scheduling server via the network to request another appointment time slot,
instructions for storing in the datastore. In response to storing the assignment of the second customer to the first appointment time slot in the datastore, an unavailability indication of the first appointment time slot; and
instructions for sending, in response to at least one of the matching and the assignment of the second customer to the first appointment time slot, a signal to the second customer via the network indicating that the first appointment time slot of the plurality of requested standby appointment time slots preferences requested by the second customer has been scheduled without requiring the second customer to connect with the scheduling server via the network to obtain an earlier appointment time slot than the first appointment time slot thereby preventing a reduction in bandwidth of the network.

16. The computer readable storage medium as recited in claim 15, wherein the instructions for matching one of the plurality of customer requested standby time slots requested by the second customer to the one of the plurality of appointment time slots previously indicated unavailable but presently available includes selecting one customer of the plurality of customers for matching based on a preference level characteristic assigned to the customer, and wherein the preference level characteristic assigned to the customer is based on a customer revenue history with the service provider, a customer longevity with the service provider, a customer tier level of service with the service provider, and a type of customer relationship with the service provider.

17. The system as recited in claim 1 further comprising:
circuitry to store in the datastore, in response to storing the assignment of the second customer to the second appointment time slot in the datastore, an unavailability indication of the second appointment time slot; and
circuitry to store in the datastore, in response to the assignment of the second customer to the first appointment time slot, a presently available indication for the second appointment time slot.
